(19) United States
(12) Patent Application Publication
(10) Pub. No.: US 2010/0294803 A1
(43) Pub. Date: Nov. 25, 2010

(54) MACHINE FOR THE SUPPLY OF THE TOOTHPASTE BY WAY OF SPREADING THE SAME ON A TOOTHBRUSH

(76) Inventor: Sedat Tetikli, Istanbul (TR)

Correspondence Address: AKERMAN SENTERFITT, P.O. BOX 3188, WEST PALM BEACH, FL, 33402-3188, US

(21) Appl. No.: 12/864,442

(22) PCT Filed: Feb. 12, 2009
(86) PCT No.: PCT/TR09/00024

§ 371 Date: Jul. 23, 2010

(30) Foreign Application Priority Data
Mar. 28, 2008 (TR) 2008/02111

(51) Int. Cl. G07F 11/50

(52) U.S. Cl. 222/144

(57) ABSTRACT

The invention relates to the supply machine (1) developed for use in the places other than the houses where the people eat, in the workplaces, shopping centers, schools, hospitals and in all the other similar crowded places or in the open spaces, which machine spreads the toothpaste on a toothbrush (17) under completely hygienic conditions and enables the toothbrush (4) with the toothpaste spread thereon to be taken and used only for once by the person in the ambience.

### TECHNICAL FIELD

The present invention relates to a machine developed for use in the places other than the houses where the people eat, in the workplaces, shopping centers, schools, hospitals and in almost all the other similar crowded places or in the open spaces, which machine supplies the toothpaste by spreading it on a toothbrush only for single use under completely hygienic conditions.

### STATE OF THE ART

In the general teeth cleaning, the toothbrushes with varying design, quality and features are currently in use.

As known, the toothbrush must be maintained in a hygienic environment for health-related reasons. To exemplify the teeth cleaning tools, there exist the pocket type foldable toothbrushes and the toothbrushes that may be attached on a pocket like a pen.

The way in which the currently existing toothbrushes are used involves squeezing the toothpaste on the bristles of the toothbrush and the teeth cleaning is performed with the aid of water. There exist many teeth cleaning kits, which are presented for use by adding toothpaste to the toothbrushes already in use, and many other similar applications. However, in enclosed places like restaurants, cafes, schools, hospitals and similar crowded places or in the open spaces, the people have no possibility of brushing their teeth after they eat, in case they do not have their toothbrush with them.

As known, we must brush our teeth two or three times a day for health-related reasons. The persons who spent most of their time outside, especially the working people, frequently go to the restaurants, cafes and similar places during the day, and eat or have drink in such places. After having the meal or particularly after drinking tea or coffee, the people need to brush their teeth. For this, they have to carry their toothbrushes in their handbags. In addition, especially in the workplaces, hospitals, hotels occupied by the crowds of people, the people carry their toothbrushes in their handbags to brush their teeth or they forget the toothbrushes so that they have to buy a new one at some nearby place.

Since the toothbrushes are carried inside the handbags, they become contaminated with the microbes even though they have protective covers, and thus the individuals can easily get sick and the human health is damaged, as the toothbrush is an apparatus that enters the mouth. Moreover, toothbrushes and toothpastes occupy much space inside the handbags. This is also an undesirable condition.

In the existing state, the persons use toothpicks to clean their teeth in the restaurants, cafes, shopping centers and the similar places, which is a behavior incompatible with the rules of good manners, as well as being extremely harmful for the health of the teeth and the gum.

In cases where there is not any cleaning apparatus available, the food residues disturb the persons during the full day. Furthermore, undesirable conditions arise after a certain time, due to the growth of bacteria inside the mouth and the formation of the unpleasant odors in the mouth.

### OBJECT OF THE INVENTION

Based on the state of the art, the object of the invention is to develop a machine for use in the places other than the houses where the people eat, in the workplaces, shopping centers, schools, hospitals and in almost all the other similar crowded places or in the open spaces, which machine supplies the toothpaste by spreading it on a toothbrush only for single use under completely hygienic conditions.

Another object of the invention is to enable the people to preserve their oral health in any ambience away from the house environment. The machine according to the invention also encourages the people to preserve their oral health.

Another object of the invention is to form an automated system, which automatically spreads the toothpaste on the toothbrush to enable the individuals to brush their teeth in a faster, more practical and more hygienic manner.

Another object of the invention is to eliminate the need for the individuals to carry the toothbrushes with them. In this way, the toothbrushes and the toothpastes are prevented from occupying too much space in the handbags.

Another object of the invention is to increase the prestige of the operators, i.e. the owners of the business enterprises like hotels, cafes, restaurants and the like. In this way, the enterprise owners will provide a very important service to their customers and the use of the toothpicks will also be eliminated.

Another object of the invention is to enable the developed machine to be operated by way of inserting coins in the places open to the public or to enable the companies to have the developed machine used free of charge by their customers or to enable the hotels to have the developed machine used by the customers in a limited manner on daily basis.

In order to achieve the said objects, the invention is a machine developed for use in the places other than the houses where the people eat, in the workplaces, shopping centers, schools, hospitals and in almost all the other similar crowded places or in the open spaces, which machine spreads the toothpaste on a toothbrush under completely hygienic conditions and enables the toothbrush with the toothpaste spread thereon to be taken and used only for once by the person in the ambience characterized in that it comprises
a foam disc, on which the toothbrushes are placed in a circular arrangement, said disc being capable of performing rotational movement in connection with a main disc that rotates by means of the drive obtained from a rotating unit,
a pin drive mechanism, which provides motion with a pusher pin connected with the handle part of the toothbrush at a proper location on the foam disc, and thus enables the toothbrush to perform linear movement along with the pusher pin,
a toothpaste spreading unit, which enables the toothpaste delivered from a toothpaste cartridge and discharged through a toothpaste outlet to be spread on the toothbrush, once the head part (bristles) of the toothbrush that performs linear movement in connection with the pusher pin of the pin drive mechanism has reached the location under a toothpaste outlet.

The structural and characteristic features and all the advantages of the invention will be more clearly understood from the figures provided below and the detailed description written with reference to said figures, hence the evaluation must be made taking into consideration these figures and detailed description.

### DESCRIPTION OF THE FIGURES

FIG. 1: The overall perspective view of the machine that supplies the toothpaste by spreading it on the toothbrush

FIG. 2: The perspective view illustrating the positions of the toothbrush and the toothpaste spreading unit with respect to each other, in a state in which the front cover of the machine according to the invention is lifted off

FIG. 3: The perspective view showing the interior of the machine according to the invention in a state in which the front cover is open

FIG. 4: The perspective view showing the interior of the machine according to the invention in a state in which the protective packing is open

FIG. 5: The perspective view showing the rotating unit and the pin drive mechanism

FIG. 6: The perspective view showing the main disc and the pin drive mechanism

### REFERENCE NUMBERS

1. Supply machine
2. Body
3. Front cover
3.1 Cover lock
3.2 Hinge
3.3 Brush outlet hole
4. Toothbrush with toothpaste spread thereon
8. Suspending package
9. Packing pin
10. Screw hole
11. Foam disc
12. Pusher pin
13. Pin drive mechanism
13.1 Drive motor
5. Toothpaste spreading unit
5.1 Outlet
5.2 Drive means
5.3 Drive mechanism
5.4 Toothpaste cartridge
6. Protective packing
7. Fixing hub
13.2 Motion mechanism
14. Main disc
15. Rotating unit
16. Main carrier
17. Toothbrush
18. Pin motion channel

### DETAILED DESCRIPTION OF THE INVENTION

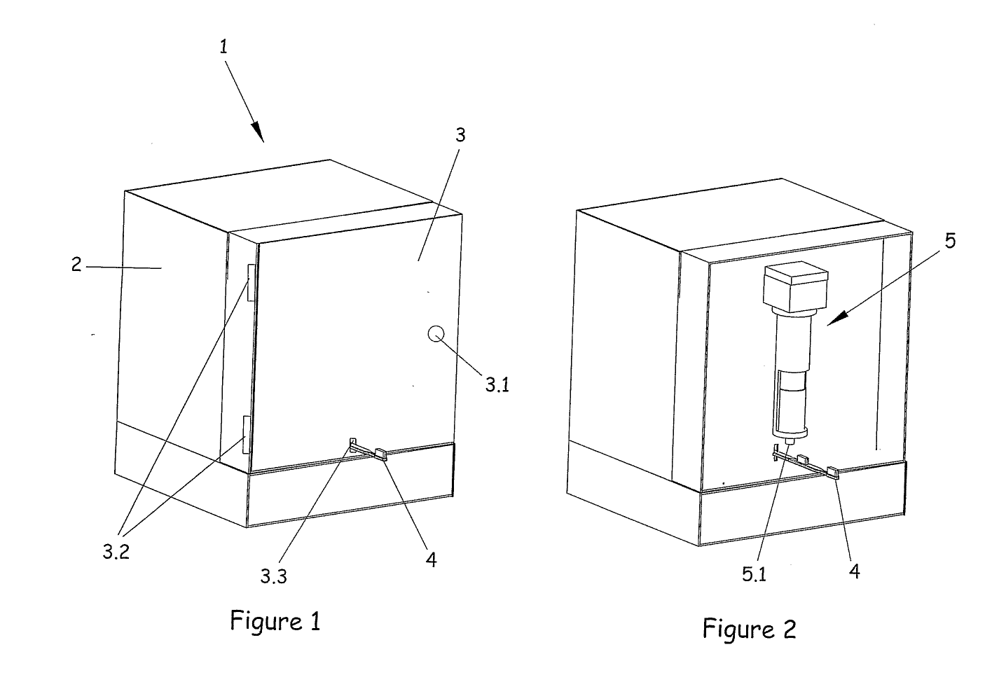

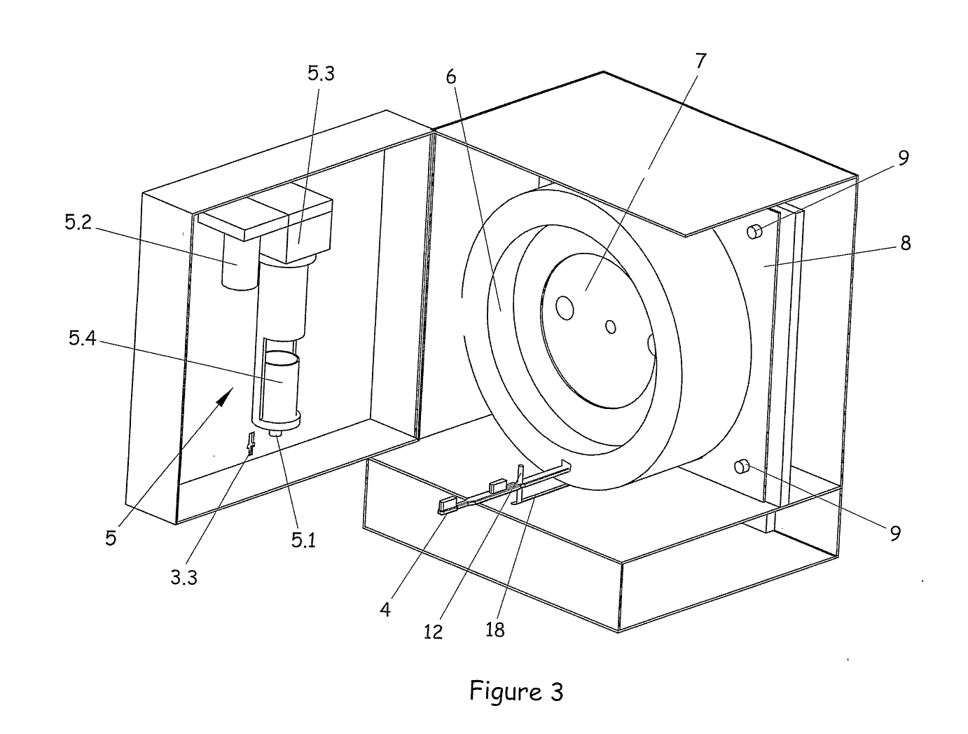

In FIG. 1, the overall view is provided of the machine (1) developed for use in the places other than the houses where the people eat, in the workplaces, shopping centers, schools, hospitals and in almost all the other similar crowded places or in the open spaces, which machine supplies the toothpaste by spreading it on a toothbrush under completely hygienic conditions only for single use. The supply machine (1) according to the invention comprises a body (2); a front cover (3) mounted via the hinges (3.2) on the body (2) so as to be able to open and close, in order to enable the toothpaste spreading unit (5) seen in FIG. 2 to be suspended and to remain in hygienic condition; a cover lock (3.1) that enables the front cover (3) to be opened and closed; a toothbrush outlet hole (3.3) formed on the front cover (3) through which the toothbrush (4) with the toothpaste spread thereon exits.

In FIG. 2, the perspective view is provided, illustrating the positions of the toothbrush (4) with the toothpaste spread thereon and the toothpaste spreading unit (5) with respect to each other, in a state in which the front cover (3) of the supply machine (1) according to the invention is lifted off. The proper amount of toothpaste is emptied via the outlet (5.1) of the toothpaste spreading unit (5) on the bristles of the toothbrushes that protrude from the interior of the machine (1). Then, the toothbrush (4) having the toothpaste spread thereon and protruding through the toothbrush outlet hole (3.3) may be taken by the user so that the teeth may be brushed. Owing to the supply machine (1) according to the invention, the toothbrush (4) on which the toothpaste is automatically spread under completely hygienic conditions enables the individuals to brush their teeth also in the open or enclosed places outside their house.

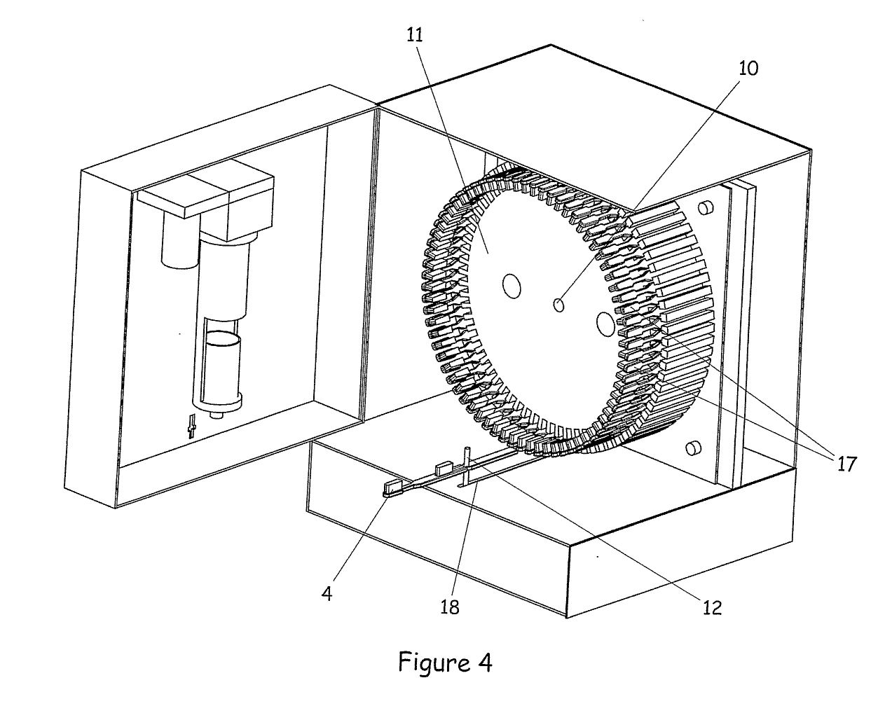

As seen in FIG. 3 and FIG. 4, the toothpaste spreading unit (5) mounted on the inside of the front cover (3) comprises a drive mechanism (5.3) driven by the drive means (5.2), which is preferably a motor. The drive mechanism (5.3) enables the toothpaste inside a toothpaste cartridge (5.4) with which it is connected to be spread on the toothbrush. Preferably, a screw shaft mechanism is used as the drive mechanism (5.3). The motor, i.e. the drive means (5.2), rotates the screw shaft, i.e. the drive mechanism (5.3), to drive the shaft that pushes the slider pump inside the toothpaste cartridge (5.4). In this way, the toothpaste inside the cartridge (5.4) exits through the outlet (5.1) and is discharged on the toothbrush. The toothbrush (4) with the toothpaste spread thereon passes and exits through the brush outlet hole (3.3) formed on the front cover (3) and is used by the individual.

A protective packing (6) manufactured from an expendable package material is used to hygienically stop the contact with the external ambience, of the toothbrushes (17) located inside the supply machine (1) and arranged in a circular manner on a foam disc (11). Also, a suspension package (8) is used that enables the expendable material to be protected from the external ambience and be suspended. The suspension of the expendable material and the centering of the disc and the securing of the suspending package (8) are performed by means of the packing pins (9).

The foam disc (11) is connected with a main disc (14) seen in FIG. 6. The process of fixing the foam disc (11) on the main disc (14) is performed by means of a fixing hub (7) seen in FIG. 3. Main disc (14) enables the foam disc (11) to be carried and to rotate at the center. The fixing hub (7) that enables the foam disc (11) carrying the toothbrushes (17) to be fixed on the main disc (14) carries out this process by way of being secured into a screw hole (10).

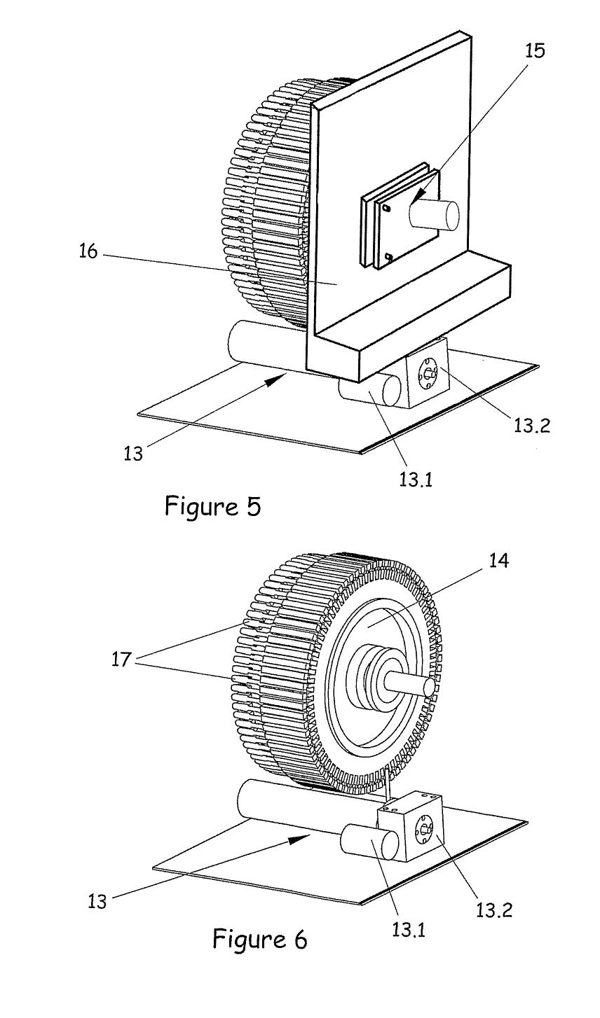

As seen in FIG. 5, the main disc (14) is rotated by means of a rotating unit (15) mounted on a main carrier (16). As the rotating unit (15), a motor with reducer is preferably used. The main disc (14), rotated by the rotating unit (15), rotates along with itself the foam disc (11) with which it is connected, to enable the toothbrushes (17) present on the foam disc (11) to be sequentially used.

As seen in FIG. 4, the toothbrushes (17) on the foam disc (11) perform a linear motion along the pin motion channel (18) by means of a pusher pin (12), and advance towards the underneath of the toothpaste spreading unit (5). The toothpaste supplied from the toothpaste spreading unit (5) is emptied on the toothbrush (17) that performs forward linear motion by means of the pusher pin (12).

The linear motion of the pusher pin (12) is performed by means of the pin drive mechanism (13) seen in FIGS. 5 and 6. The pin drive mechanism (13) comprises a drive motor (13.1) and a motion mechanism (13.2) driven by the drive motor (13.1). Preferably, a screw shaft mechanism is used as the motion mechanism (13.2). The motion mechanism (13.2) enables the pusher pin (12) with which it is connected to perform back and forth linear motion inside the pin motion channel (18). The motion mechanism (the screw shaft mechanism) (13.2) linearly moves the pusher pin (12) that drags the toothbrush (17) from the foam disc (11) to the toothpaste spreading unit (5).

When the start button of the machine is pressed by the user, the pusher pin (15) separates from the toothpaste outlet (5.1) and is positioned by means of the pin drive mechanism (13) at the handle part of the toothbrush (17) and waits at this position. Then, the main disc (14) positions, via a rotational movement with the aid of the rotating unit (15), the toothbrush (17) on the foam disc towards the direction of the pin drive mechanism (13). The toothbrush (17) positioned on the foam disc (11) becomes ready for a linear motion towards the toothpaste outlet (5.1). The toothbrush (17) at this position performs linear motion by means of the pin drive mechanism (13) to be transferred to the toothpaste outlet (5.1) and is positioned here. The toothpaste is spread from the toothpaste cartridge (5.4) onto the toothbrush (17) waiting at this position, by means of a drive mechanism (5.3), preferably a screw shaft mechanism, which is driven by the drive means (5.2), preferably a motor with reducer. The toothbrush (4) with the toothpaste spread thereon performs linear motion towards the brush outlet hole (3.3) by means of the pusher pin (12), and is transferred to the exterior ambience in order to be used by the individual.

1. A supply machine developed for use in the places other than the houses, such as workplaces, shopping centers, schools, hospitals and in all the other similar crowded places or in the open spaces, which machine spreads toothpaste on a toothbrush under hygienic conditions and enables the toothbrush with the toothpaste spread thereon to be taken and used only once comprising:
a foam disc, on which a plurality of toothbrushes are placed in a circular arrangement, said disc being capable of performing rotational movement in connection with a main disc that rotates by means of a drive obtained from a rotating unit,
a pin drive mechanism, which provides motion to a pusher pin connected with a the handle part of a toothbrush at a selected location on the foam disc, and thus enables the toothbrush to perform linear movement along with the pusher pin; and
a toothpaste spreading unit, which enables toothpaste delivered from a toothpaste cartridge and discharged through a toothpaste outlet to be spread on the toothbrush, once a head part (bristles) of the toothbrush that performs linear movement in connection with the pusher pin of the pin drive mechanism has reached a defined location under the toothpaste outlet.

2. The supply machine according to claim 1, wherein a motor with a reducer is used as the rotating unit.

3. The supply machine according to claim 1, wherein said pin drive mechanism comprises a drive motor and a motion mechanism driven by the drive motor and enabling the linear motion of the pusher pin.

4. The supply machine according to claim 3, wherein a screw shaft mechanism is used as the motion mechanism.

5. The supply machine according to claim 1, further comprising a pin motion channel, which enables the toothbrushes to perform linear motion by means of the pusher pin and to advance towards the underneath of the toothpaste spreading unit.

6. The supply machine according to claim 1, wherein said toothpaste spreading unit comprises a drive mechanism, which is driven by a drive means, and enables the toothpaste inside the toothpaste cartridge to exit through said toothpaste outlet and to be emptied onto the toothbrush.

7. The supply machine according to claim 6, wherein a motor is used as the drive means, and a screw shaft mechanism is used as the drive mechanism.

8. The supply machine according to claim 1, comprising:
a body;
a front cover mounted via hinges on the body so as to be able to open and close, in order to enable the toothpaste spreading unit to be suspended and to remain in hygienic condition;
a cover lock that enables the front cover to be opened and closed; and
a toothbrush outlet hole formed on the front cover through which the toothbrush with the toothpaste spread thereon exits.

9. The supply machine according to claim 1, further comprising a protective packing manufactured from an expendable package material in order to hygienically stop contact with the external environment, of the toothbrushes arranged in a circular manner on the foam disc located inside the supply machine.

10. The supply machine according to claim 1, further comprising a fixing hub that enables the foam disc to be fixed onto the main disc.

11. The supply machine according to claim 1, further comprising a suspending package that protects expendable materials from the external environment and to suspend the same, and packing pins used to suspend the expendable material and to center the foam disc and to fix the suspending package.

12. A method carried out by a supply machine developed for use in places other than houses, such as workplaces, shopping centers, schools, hospitals and in all the other similar crowded places or in open spaces, which machine spreads toothpaste on a toothbrush under hygienic conditions and enables the toothbrush with the toothpaste spread thereon to be taken and used only once, comprising the process steps of:
placing a plurality of toothbrushes in a circular arrangement on a foam disc able to perform rotational movement in connection with a main disc which performs rotational movement by means of a drive obtained from a rotating unit;
upon the user pressing the start button of the machine, locating a pusher pin at the handle part of one of the toothbrushes by means of a pin drive mechanism and said pin waiting at this position;
positioning the main disc, via a rotational movement with the aid of the rotating unit, the toothbrush on the foam disc so that it will be aligned with the pusher pin,
linearly moving the toothbrush along with the pusher pin, to reach the underneath of a toothpaste outlet of a toothpaste spreading unit; and
spreading on the toothbrush the toothpaste, supplied from a toothpaste cartridge of the toothpaste spreading unit and discharged through the toothpaste outlet.
